(19) United States
(12) Patent Application Publication
(10) Pub. No.: US 2016/0300438 A1
(43) Pub. Date: Oct. 13, 2016

(54) METHOD AND SYSTEM FOR SEAMLESS TRANSITIONS BETWEEN GAME TYPES FOR PORTABLE COMPUTER SYSTEMS

(71) Applicant: iPro, Inc., Incline Village, NV (US)

(72) Inventors: Shanmugapriyan DEVARAJ, Portland, OR (US); David ORTIZ, Newcastle, WA (US); Robert MELENDRES, Incline Village, NV (US); Shanmugam CHINNASAMY, Bellevue, WA (US)

(21) Appl. No.: 14/684,077

(22) Filed: Apr. 10, 2015

(51) Int. Cl. G07F 17/32

(52) U.S. Cl. CPC G07F 17/3241; G07F 17/3204; G07F 17/3232

(57) ABSTRACT

Systems and methods for seamless transitions between game types for portable computer systems. In accordance with a first method embodiment of the present invention, a computer implemented method includes determining a location of a mobile device, determining a legal jurisdiction of the mobile device based on the location and automatically presenting a legal type of game to a user of the mobile device based on the legal jurisdiction. The method may include sending the location of the mobile device to an external computer system. The determination of a legal jurisdiction of the mobile device may be performed external to the mobile device.

### RELATED APPLICATIONS

This application is related to co-pending, commonly owned U.S. patent application Ser. No. ______/______,______, attorney docket IPRO-0002-01.01US, filed Apr. 10, 2015, entitled “System and Method for Accepting and Creating Electronic Wagers” to Ortiz et al., and is hereby incorporated by reference herein in its entirety.

This application is related to co-pending, commonly owned U.S. patent application Ser. No. ______/______,______, attorney docket IPRO-0003-01.01US, filed Apr. 10, 2015, entitled “System and Method for On-line Wagering on Real Time Events” to Ortiz et al., and is hereby incorporated by reference herein in its entirety.

This application is related to co-pending, commonly owned U.S. patent application Ser. No. ______/______,______, attorney docket IPRO-0004-01.01US, filed Apr. 10, 2015, entitled “System and Method for On-line Fantasy Wagering” to Ortiz et al., and is hereby incorporated by reference herein in its entirety.

This application is related to co-pending, commonly owned U.S. patent application Ser. No. ______/______,______, attorney docket IPRO-0005-01.01US, filed Apr. 10, 2015, entitled “System and Method for On-Line Multi-Player Interactive Wagering” to Devaraj et al., and is hereby incorporated by reference herein in its entirety.

This application is related to co-pending, commonly owned U.S. patent application Ser. No. ______/______,______, attorney docket IPRO-0006-01.01US, filed Apr. 10, 2015, entitled “Graphical User Interface for On-Line Gaming” to Ortiz et al., and is hereby incorporated by reference herein in its entirety.

U.S. Pat. No. 8,790,176, entitled “System and Method for Real Time Interactive Entertainment” to Hopf and Ortiz, is hereby incorporated by reference in its entirety.

### FIELD OF INVENTION

Embodiments of the present invention relate to the field of electronic applications for mobile computer systems. More specifically, embodiments of the present invention relate to systems and methods for seamless transitions between game types for portable computer systems.

### BACKGROUND

There are myriad laws and regulations governing gambling or gaming, including on-line gambling. The application of most such laws is based on a person's geographic location, for example, whether the person is within a particular government's jurisdictional boundaries. For example, the U.S. State of Nevada may allow one type of wager on a sporting event as lawful, whereas a different state may not allow such a wager.

Such legal differences have given rise to a variety of types of gambling or gambling-like electronic games. For example, a first type of game may allow real money wagers. A “simple” real money wager may comprise two parties making a wager, for a particular amount of currency, on the outcome of a sporting event, and the loser pays the agreed-upon amount to the winner. A more complex “real money” bet may be that the next play of a football game is a pass to wide receiver number 81 for ten to twenty yards. The actual exchange of money is typically handled by a third party, for example, the game provider, which may be an on-line casino, etc.

Another type of wager may involve a virtual currency that is known as or referred to as “social chips.” Social chips may be wagered in a manner similar to real money, but are not redeemable for currency or items of significant monetary value. Social chips are typically redeemed in a virtual world for rankings, banners, tokens, bragging rights, and the like. Social chips may serve as a way to “keep score,” for example, to determine who among a group of friends or on line acquaintances is better at predicting outcomes of sporting events.

A third type of wager is known as or referred to as “fantasy” wagering. Many, but not all, U.S. States allow wagering “real” money on “fantasy” sports, while outright “sports betting” is not allowed. Fantasy wagering is generally based on a performance of a specific player, or a collection of specific players, over a number of plays or a duration of game time. For example, the results of such wagers may be based on player skill more than mere chance. The cumulative effect of a number of plays for a specific player may legally categorize such “fantasy” wagering as an allowable game of “skill.” In contrast, more typical “sports betting,” e.g., a simple bet on the outcome of a game, is generally viewed as a game of “luck,” and is typically more restricted. It is to be appreciated that “fantasy” games, e.g., wagers based on cumulative results of specified players, may be played for real money or virtual money, e.g., “social chips.”

Unfortunately, under the conventional art, a user or player is burdened with figuring out what types of gaming, if any, are allowed in his or her location. Further, the user must select from a number of game types. As a deleterious consequence, both the user and the game provider may be in violation of numerous laws.

In addition, under the conventional art, a user and a gaming application must maintain separate accounts for social chips versus real-money balances, and the behavior of these accounts must vary based on jurisdictional differences. For example, a user's “winnings” may not be added to a real-money balance if the user is not within a jurisdiction that allows real-money gaming. However, withdrawals from a real-money balance, e.g., to purchase social chips, but not to wager, may be allowed. The complexities of managing separate social chips versus real-money accounts, coupled with variations of allowable play detract from a user's enjoyment and create additional exposure to violation of numerous laws.

### SUMMARY OF THE INVENTION

Therefore, what is needed are systems and methods for seamless transitions between game types for portable computer systems. What is additionally needed are systems and methods for seamless transitions between game types for portable computer systems between game types based on a geolocation of the mobile device. A need also exists for systems and methods for seamless transitions between game types for portable computer systems without user intervention. Further, a need exists for systems and methods for seamless transitions between game types for portable computer systems that present a unified account structure to a user. Still further, a need exists for systems and methods for seamless transitions between game types for portable computer systems that are compatible and complementary with existing systems and methods of on-line and/or mobile gaming. Embodiments of the present invention provide these advantages.

In accordance with a first method embodiment of the present invention, a computer implemented method includes determining a location of a mobile device, determining a legal jurisdiction of the mobile device based on the location and automatically presenting a legal type of game to a user of the mobile device based on the legal jurisdiction. The method may include sending the location of the mobile device to an external computer system. The determination of a legal jurisdiction of the mobile device may be performed external to the mobile device.

In accordance with another embodiment of the present invention, a method of game play includes in a mobile computer system, reporting a present location of the mobile computer system over a communication channel, the mobile computer system receiving, from the communication channel, information related to the present location wherein the information indicates a legal game play type and configuring a plurality of software modules of a game application within the mobile computer system to implement a legal game application in accordance with the legal game play type. The method also includes executing the legal game application on the mobile computer system wherein the executing comprises: interfacing with a user of the legal game application to accept a plurality of game wagers therefrom and based on outcomes of the plurality of game wagers, displaying updated balances of a user account of the user on the mobile computer system, wherein the plurality of game wagers are made in relation to a real-time game being played.

In accordance with a further embodiment of the present invention, a mobile electronic system includes one or more processors coupled to a bus, a memory coupled to the one or more processors, wherein the memory comprises a gaming application, a position determining system coupled to the bus operable to determine a geolocation of the electronic system and a graphical user interface coupled to the bus. The mobile electronic system is configured to report a present location of the mobile electronic system over a communication channel, receive, from the communication channel, information related to the present location wherein the information indicates a legal game play type, automatically configure a plurality of software modules of the gaming application within the mobile electronic system to implement a legal game application in accordance with the legal game play type, execute the legal game application, wherein the executing comprises: interfacing with a user of the legal game application to accept a plurality of game wagers therefrom and based on outcomes of the plurality of game wagers, display updated balances of a user account of the user on the display, wherein the plurality of game wagers are made in relation to a real-time game being played.

In accordance with yet another embodiment of the present invention, an article of manufacture includes a computer readable medium having instructions stored thereon that, responsive to execution by an electronic system, cause the electronic system to perform operations including determining a location of a mobile device, determining a legal jurisdiction of the mobile device based on the location and automatically presenting a legal type of game to a user of the mobile device based on the legal jurisdiction.

### BRIEF DESCRIPTION OF THE DRAWINGS

The accompanying drawings, which are incorporated in and form an integral part of this specification, illustrate embodiments of the invention and, together with the description, serve to explain the principles of the invention. Unless otherwise noted, the drawings are not drawn to scale.

FIG. 1 illustrates an exemplary block diagram of an exemplary electronic system, which may be used as a platform to implement embodiments of the present invention.

FIG. 2 is a data flow diagram, in accordance with embodiments of the present invention.

FIG. 3A illustrates an exemplary graphical user interface (GUI) for wager selection, in accordance with embodiments of the present invention.

FIG. 3B illustrates an exemplary graphical user interface (GUI) for wager selection, in accordance with embodiments of the present invention.

FIG. 4 illustrates an exemplary graphical user interface (GUI) for managing a player's account, in accordance with embodiments of the present invention.

FIG. 5 illustrates an exemplary method for seamless transitions between game types, in accordance with embodiments of the present invention.

FIG. 6 illustrates an exemplary method for game play, in accordance with embodiments of the present invention.

### DETAILED DESCRIPTION

Reference will now be made in detail to various embodiments of the present invention, examples of which are illustrated in the accompanying drawings. While the invention will be described in conjunction with these embodiments, it is understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the invention, numerous specific details are set forth in order to provide a thorough understanding of the invention. However, it will be recognized by one of ordinary skill in the art that the invention may be practiced without these specific details. In other instances, well known methods, procedures, components, and circuits have not been described in detail as not to unnecessarily obscure aspects of the invention.

### NOTATION AND NOMENCLATURE

Some portions of the detailed descriptions which follow (e.g., methods 500 and 600) are presented in terms of procedures, steps, logic blocks, processing, and other symbolic representations of operations on data bits that may be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “accepting” or “selecting” or “determining” or “displaying” or “computing” or “sending” or “receiving” or “reducing” or “detecting” or “setting” or “accessing” or “placing” or “testing” or “forming” or “mounting” or “removing” or “ceasing” or “stopping” or “coating” or “processing” or “performing” or “generating” or “adjusting” or “creating” or “executing” or “continuing” or “indexing” or “translating” or “calculating” or “measuring” or “gathering” or “running” or the like, refer to the action and processes of, or under the control of, a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It is appreciated that there are myriad regulations regarding on line wagering, and this application does not attempt to cover all permutations of jurisdictions and types of gaming that may or may not be allowed. Embodiments in accordance with the present invention are well suited to presenting legal games to a user, world wide, automatically and without user intervention.

### Method and System for Seamless Transitions Between Game Types for Portable Computer Systems

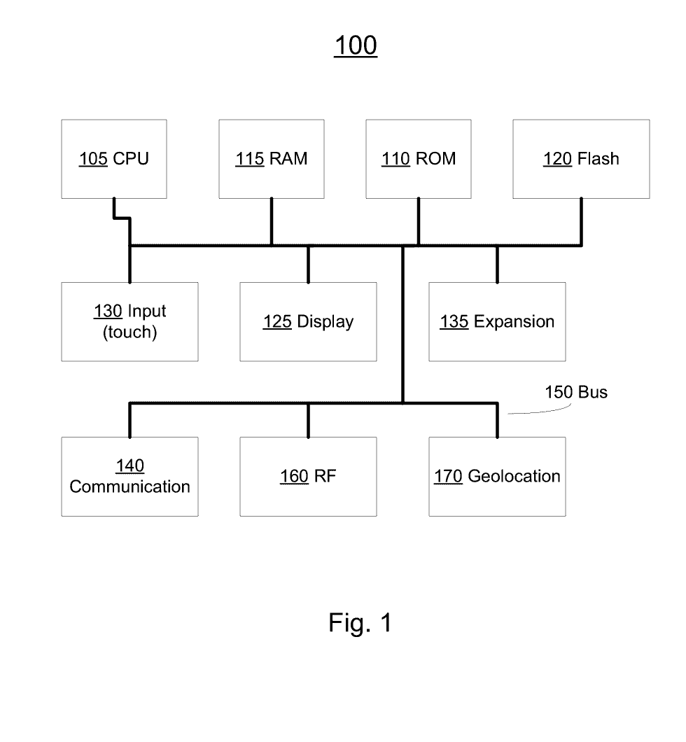

FIG. 1 illustrates an exemplary block diagram of an exemplary electronic system 100, which may be used as a platform to implement embodiments of the present invention. Electronic system 100 may be battery-powered, in some embodiments. Electronic system 100 may be a “server” computer system, in some embodiments. Electronic system 100 may comprise a desktop or generally “fixed location” computer system, in some embodiments. Electronic system 100 may comprise aportable computer system, e.g., a “smart” phone. Electronic system 100 may comprise a “wearable” computer system, e.g., a “smart” watch or an “eye-glasses-mounted” computer system. Electronic system 100 includes an address/data bus 150 for communicating information, a central processor 105 functionally coupled with the bus for processing information and instructions. Central processor 105 may comprise a single processor or multiple processors, e.g., a multi-core processor, or multiple separate processors, in some embodiments. Electronic system 100 also includes a volatile memory 115 (e.g., random access memory RAM) coupled with the bus 150 for storing information and instructions for the central processor 105, and a non-volatile memory 110 (e.g., read only memory ROM) coupled with the bus 150 for storing static information and instructions for the processor 105. Electronic system 100 also optionally includes a changeable, non-volatile memory 120 (e.g., flash) for storing information and instructions for the central processor 105 which can be updated after the manufacture of system 100. In some embodiments, only one of ROM 110 or Flash 120 may be present.

Also included in electronic system 100 of FIG. 1 is an optional input device 130. Device 130 can communicate information and command selections to the central processor 100. Input device 130 may be any suitable device for communicating information and/or commands to the electronic system 100. For example, input device 130 may take the form of a keyboard, buttons, a joystick, a track ball, an audio transducer, e.g., a microphone, a touch sensitive digitizer panel, eyeball scanner and/or the like. A touch sensitive digitizer panel may comprise any suitable technology, e.g., capacitive, resistive, optical, acoustic and/or pressure responsive touch panels. Activation of a “touch” sensitive digitizer panel may not require actual touching of the panel 130 or the electronic system 100, in some embodiments. For example, capacitive touch panels may sense proximity of a user's finger or an eyeball scanner may detect a direction of a user's gaze.

The display unit 125 utilized with the electronic system 100 may comprise a liquid crystal display (LCD) device, cathode ray tube (CRT), field emission device (FED, also called flat panel CRT), light emitting diode (LED), plasma display device, electro-luminescent display, electronic paper, electronic ink (e-ink) or other display device suitable for creating graphic images and/or alphanumeric characters recognizable to the user. Display unit 125 may have an associated lighting device, in some embodiments. Display unit 125 may comprise a head-mounted display, in some embodiments.

The touch sensitive digitizer panel 130 is generally associated with the display unit 125. For example, a function of the touch sensitive digitizer panel 130 generally associated with the display unit 125 is to localize a touch input, e.g., from a finger or stylus, to a portion of display unit 125, for example, a single icon image displayed on display unit 125. The touch sensitive digitizer panel may be in front of the actual display device, e.g., in a viewer's optical path, or the touch sensitive digitizer panel may be outside of a viewer's optical path, e.g., behind or to the side of the display device. The touch sensitive digitizer panel 130 may have different planar dimensions in comparison to planar dimensions of a display unit 125. For example, the touch sensitive digitizer panel 130 may be smaller than display unit 125, e.g., the display unit 125 may extend beyond the touch sensitive digitizer panel 130. Similarly, the touch sensitive digitizer panel 130 may be larger than display unit 125, e.g., the touch panel may extend beyond the display unit. The touch sensitive digitizer panel may be integral to a display assembly, or a separate assembly within the electronic system 100. A touch sensitive digitizer panel is not required.

Electronic system 100 also optionally includes an expansion interface 135 coupled with the bus 150. Expansion interface 135 can implement many well known standard expansion interfaces, including without limitation the Secure Digital Card interface, universal serial bus (USB) interface, Compact Flash, Personal Computer (PC) Card interface, CardBus, Peripheral Component Interconnect (PCI) interface, Peripheral Component Interconnect Express (PCI Express), mini-PCI interface, IEEE 1394, Small Computer System Interface (SCSI), Personal Computer Memory Card International Association (PCMCIA) interface, Industry Standard Architecture (ISA) interface, RS-232 interface, and/or the like. In some embodiments of the present invention, expansion interface 135 may comprise signals substantially compliant with the signals of bus 150.

A wide variety of well known devices may be attached to electronic system 100 via the bus 150 and/or expansion interface 135. Examples of such devices include without limitation rotating magnetic memory devices, flash memory devices, digital cameras, wireless communication modules, digital audio players and Global Positioning System (GPS) devices.

System 100 also optionally includes a communication port 140. Communication port 140 may be implemented as part of expansion interface 135. When implemented as a separate interface, communication port 140 may typically be used to exchange information with other devices via communication-oriented data transfer protocols. Examples of communication ports include without limitation RS-232 ports, universal asynchronous receiver transmitters (UARTs), USB ports, infrared light transceivers, ethernet ports, IEEE 1394 and synchronous ports.

System 100 optionally includes a radio frequency module 160, which may implement a mobile telephone, a wireless network, e.g., IEEE 802.11 (“Wi-Fi”), Bluetooth, a pager, or a digital data link. Radio frequency module 160 may be interfaced directly to bus 150, via communication port 140, via expansion interface 135, or any suitable interface. Various features of electronic system 100 may be implemented by a combination of hardware and/or software. Electronic system 100 may comprise additional software and/or hardware features (not shown) in some embodiments.

Various modules of system 100 may access computer readable media, and the term is known or understood to include removable media, for example, Secure Digital (“SD”) cards, CD and/or DVD ROMs, diskettes and the like, as well as non-removable or internal media, for example, hard drives, RAM, ROM, flash, and the like.

Electronic system 100 may comprise one or more geolocation determining features 170. For example, electronic system 100 may determine its position by use of a Global Positioning System (GPS), including, for example, the United States Global Position System, the planned European Union Galileo positioning system, India's Indian Regional Navigational Satellite System and/or the Chinese Compass navigation system. Electronic system 100 may also determine its position via a mobile telephone network, for example, identifying, measuring signal strength, and/or triangulation of cell towers. Electronic system 100 may also determine its position from known locations of wireless networks, e.g., WiFi hotspots, from an internet protocol (IP) address, or any other applicable location service(s). Geolocation determining features 170 may comprise dedicated hardware, or may utilize components with one or more other uses.

In accordance with embodiments of the present invention, a gaming application program running on an embodiment of electronic system 100 automatically determines the device's geolocation. While embodiments in accordance with the present invention are generally disclosed using examples of portable computer systems, e.g., “smart phones,” a device's geolocation should be determined even if the electronic system is of a type not generally considered to be portable, e.g., a “desk top” computer system, in accordance with embodiments of the present invention. Based on the geolocation, the device automatically and transparently to the user switches among at least two different types of games. For example, the types of games may include real money gambling, social chips gambling, and/or fantasy gambling.

When the electronic system 100 is located within a jurisdiction that does not allow gambling, only non-gambling types of games, e.g., games for social chips, are made available to the user. When the electronic system 100 is located within a jurisdiction that does allow gambling, then real money gambling is made available to the user. It is appreciated that not all jurisdictions that allow some types of gambling allow all types of gambling. For example, some jurisdictions allow “real money” wagering on “games of skill,” e.g., “fantasy sports,” while prohibiting “real money” wagering on “games of chance,” e.g., singular outcomes. Accordingly, embodiments in accordance with the present invention may provide further granularity as to types of games. For example, based on the laws of a particular jurisdiction, a device may switch among more than one type of real money gambling, e.g., based on a type of wager, in addition to social chips gaming.

In accordance with embodiments of the present invention, a mobile device reports its geolocation to a server computer system. Based on the device's reported geolocation, the server computer system determines the mobile device's jurisdiction and the types of games available in that jurisdiction, and sends this information to the mobile device. Based on information of the types of games available in the present jurisdiction, the mobile device automatically presents allowable types of games. In this novel manner, the mobile device is not burdened with the complexities of gambling regulations among all possible jurisdictions. In accordance with other embodiments, the mobile device determines its own jurisdiction and the types of games available in that jurisdiction, without inquiring of another computer system, e.g., based on information local to the mobile device.

In accordance with embodiments of the present invention, a mobile device may periodically determine its position, e.g., during game play. If it is determined that the device is currently within a jurisdiction that allows a different type of game play, the device will automatically and seamlessly offer the different type of game play to the user. For example, if the device has moved from a first jurisdiction that does not allow real money gaming to a second jurisdiction that allows real money gaming, a user will be presented with real money games. For example, a first wager, in the first jurisdiction, may be for social chips. A subsequent wager, in the second jurisdiction, may be for real money. A new game type based on jurisdiction may be presented, for example, if the second jurisdiction is superset of first jurisdiction. It is to be appreciated that a user need not take any action, e.g., select a gaming mode, restart an application, etc., to invoke such a change. Conversely, if the device has moved from a first jurisdiction that allows real money gaming to a second jurisdiction that does not allow real money gaming, a user will be presented with virtual currency games.

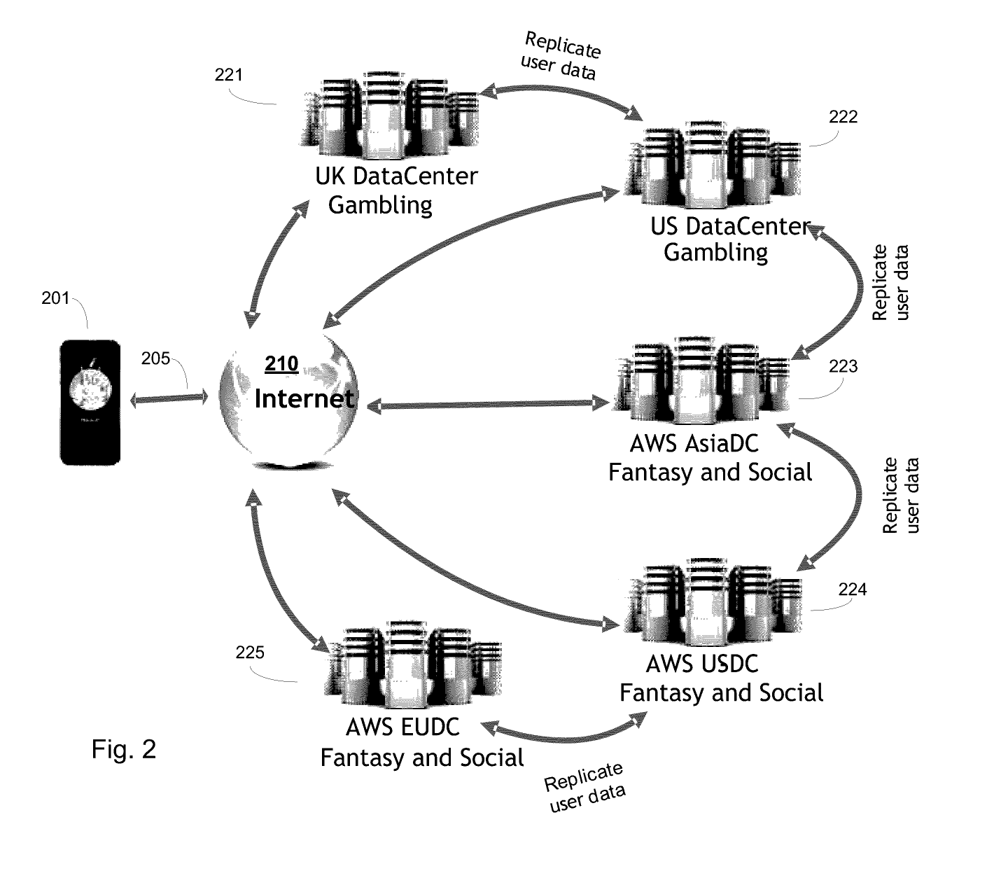

FIG. 2 illustrates data flow, in accordance with embodiments of the present invention. Portable computer system 201, which may be an embodiment of exemplary electronic system 100 as illustrated in FIG. 1, communicates 205 with the internet 210. The communication may take any suitable form, for example, via mobile data or a wireless local area network (LAN). In accordance with embodiments of the present invention, a first such communication may comprise information of a geolocation of the portable computer system 201. The geolocation information is forwarded to one of a plurality of regional data centers 221, 222, 223, 224, 225. The geolocation information may be forwarded to a closest data center, or the information may be forwarded to an arbitrary data center, in accordance with embodiments of the present invention.

The regional data centers 221, 222, 223, 224, 225 each cover a defined territory, which may overlap. Each regional data center is configured to determine what types of game play, e.g., real-money, social chips and/or fantasy, is permitted at every point within its defined territory. For example, the US Data Center 222 is configured to report that real money gaming is allowed within the State of Nevada, while, for example, only social chips and fantasy games are legal within the State of California.

Once the geolocation information is received at a regional data center, e.g., “UK Data Center” 221, the regional data center determines if the received geolocation information corresponds to a location within the service area of the regional data center. Each regional data center 221, 222, 223, 224, 225 serves a specific geographic region. For example, “UK Data Center” 221 serves the United Kingdom geographic region, and “US Data Center” 222 serves the United States. If the received geolocation information corresponds to a location within the service area of the regional data center, that regional data center determines an allowable type of game play, e.g., real-money, social chips and/or fantasy, and sends a message back to the portable computer system 201 indicating what type(s) of game(s) are legal at the portable computer system 201's present location.

If the received geolocation information does not correspond to a location within the service area of the regional data center, that regional data center forwards the geolocation information to the regional data center responsible for the current geolocation of the portable computer system 201. In accordance with embodiments of the present location, such forwarding need not be exact or accomplished in a single “hop.” Rather, a regional data center receiving geolocation information not handled by the regional data center forwards the geolocation information to another regional data center believed to be “closer” or more accurate in responding to the geolocation information. In this novel manner, a given regional data center does not need to know details of geographies covered by other data centers, nor does it need to resolve locations that may be on a border between two different jurisdictions and/or two different regions.

Once information of the current geolocation of the portable computer system 201 is received at the correct data center, that data center sends a message back to portable computer system 201. The message indicates what type(s) of game(s), e.g., real-money, social chips and/or fantasy, are legal at the portable computer system 201's present location.

User account information is maintained by one or more regional data centers, in accordance with embodiments of the present invention. Account information may include, for example, game preferences, game/wager history, account balance, credit rating, funding sources, badges or other tokens, previous location and the like. A user's account information may be stored on a single server, e.g., UK Data Center 221, on a subset of all servers, or on all servers, in accordance with embodiments of the present invention. Once a data center has determined that it is the proper data center, based on geography, to deal with the portable computer system 201, the data center will request user account information, if not already present on the data center. The user account information is replicated and/or sent from another data center. Communication among the data centers, for example, a transfer and/or replication of user account information, may be over public and/or private networks.

The following example is presented to clarify the data flow. A user has last activated a gaming application in London, England, prior to boarding a flight to the United States. After arrival, the user activates the gaming application on a portable “smart” phone (or other mobile device) 201 on the eastern shore of Lake Tahoe. The eastern shore of Lake Tahoe is located within the State of Nevada. Based, for example, on the prior use of the application, the application reports its position to UK Data Center 221, which determines, based on the position report, that the phone is located in the United States, which is outside of the area of responsibility of UK Data Center 221. The UK Data Center 221 forwards the position report to US Data Center 222. US Data Center 222 determines that the phone 201 is in Nevada and sends a message to the phone 201 that all types of wagers are available, based on the laws of Nevada, and the gaming application presents a plurality of real money wagers to the user. The US Data Center 222 determines that it does not have account information for the particular user, and requests it from, for example, UK Data Center 221.

Subsequent gaming may involve further interactions with US Data Center 222, for example, to determine available wagers on specific games or events within games, and to update account balance information based on the results of such wagers.

In accordance with embodiments of the present invention, the gaming application may periodically update its position to the regional data center, e.g., US Data Center 222. If, for example, the user is traveling west across Lake Tahoe, the user may cross into the State of California. Upon receiving information that the user is located in California, US Data Center 222 determines that the phone 201 is in California and sends a message to the phone 201 that real-money wagers are not, e.g., no longer, available, based on the laws of California, and the gaming application automatically ceases presentation of real-money wagers, and presents a plurality of social chips and/or fantasy wagers to the user.

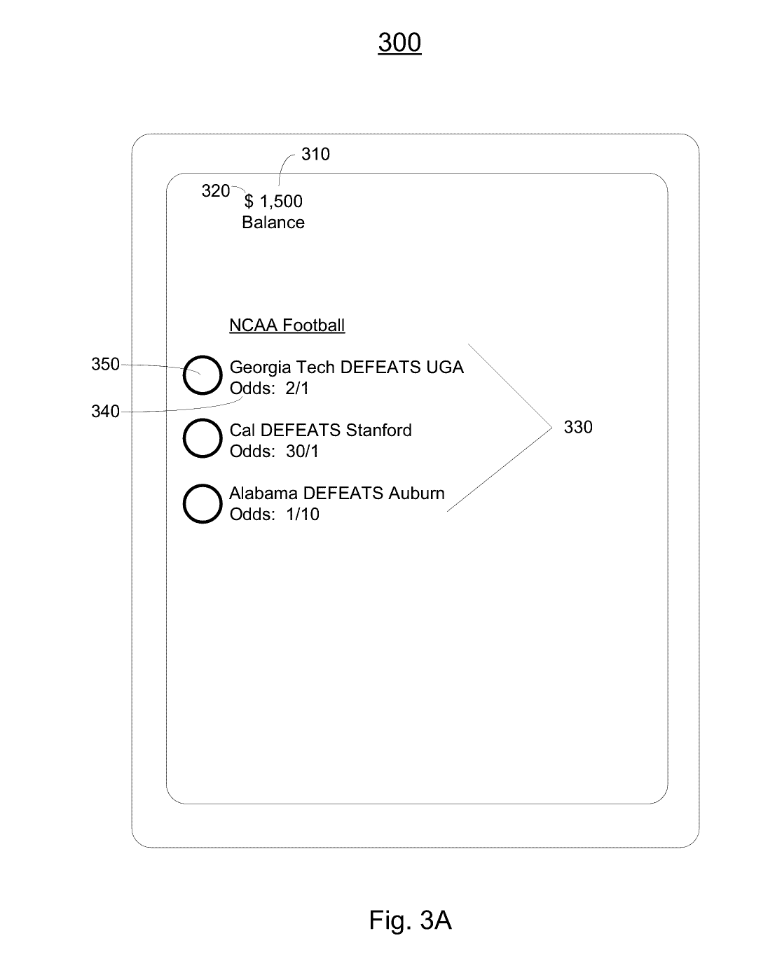

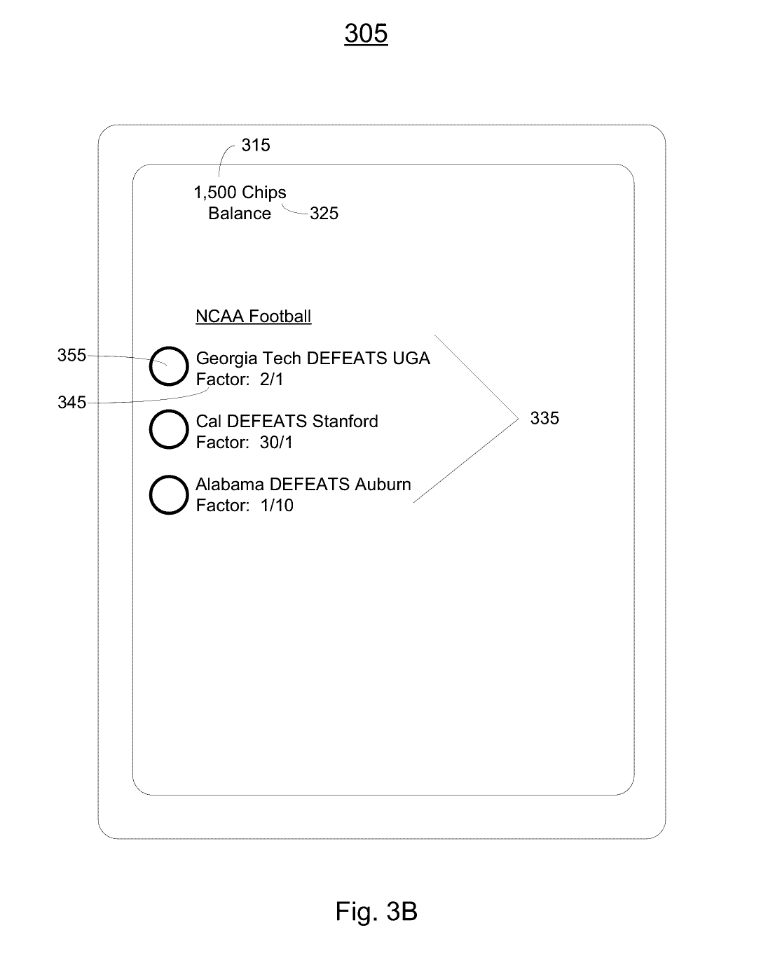

FIG. 3A illustrates an exemplary graphical user interface (GUI) 300 for wager selection, in accordance with embodiments of the present invention. Graphical user interface 300 may be presented on a mobile device, e.g., electronic system 100 of FIG. 1, in response to a determination that the mobile device is within a jurisdiction that allows real money gaming. Graphical user interface 300 comprises a user account balance display 310. User account balance display 310 indicates the available “on-deposit” amount available for any wager. In the example of FIG. 3A, the amount shown is in real currency, e.g., U.S. Dollars, as indicated by currency designator 320.

Graphical user interface 300 also comprises a list 330 of available wagers. In the example of FIG. 3A, three contests between college football teams are presented. The odds 340 of each potential wager are presented. Selection button 350 allows a user to place a wager on any of the indicated contests.

FIG. 3B illustrates an exemplary graphical user interface (GUI) 305 for wager selection, in accordance with embodiments of the present invention. Graphical user interface 305 may be presented on a mobile device, e.g., electronic system 100 of FIG. 1, in response to a determination that the mobile device is within a jurisdiction that does not allow real money gaming. Graphical user interface 305 comprises an account balance display 315. Account balance display 315 indicates the available “on-deposit” amount available for any wager. In the example of FIG. 3B, the amount shown is in a virtual currency, e.g., “Social ChipsChips,” as indicated by “ChipsChips” designator 325.

Graphical user interface 300 also comprises a list 335 of available wagers. In the example of FIG. 3B, three contests between college football teams are presented. In contrast to the graphical user interface 300 of FIG. 3A, graphical user interface 305 does not present odds. Rather, graphical user interface 305 displays a “multiplication factor” corresponding to the expected outcome of the wager. The indicated “factor” is presented rather than “odds,” to confirm that the wager is not for real money. Selection button 355 allows a user to place a wager on any of the indicated contests.

It is to be appreciated that the differences between graphical user interface 300 and graphical user interface 305 are based upon a location of a mobile device, and a determination of whether real money gaming is allowed within a jurisdiction corresponding to the location. For example, in a jurisdiction allowing real money gaming, e.g., as illustrated in graphical user interface 300 of FIG. 3A, a balance 310 is displayed in a real currency, and the odds 340 of a wager are presented. In contrast, in a jurisdiction that does not allow real money gaming, e.g., as illustrated in graphical user interface 305 of FIG. 3B, a balance 315 is displayed in a virtual currency, and multiplication factors 345, not “odds,” of available wagers are presented. It is appreciated that a user does not select whether to game in “real money” or “social chipschips.” Rather, in accordance with embodiments of the present invention, a selected type of game, from among various types of games, e.g., real money or social chips, is automatically and seamlessly presented to the user, based on a device location and corresponding jurisdictional regulations.

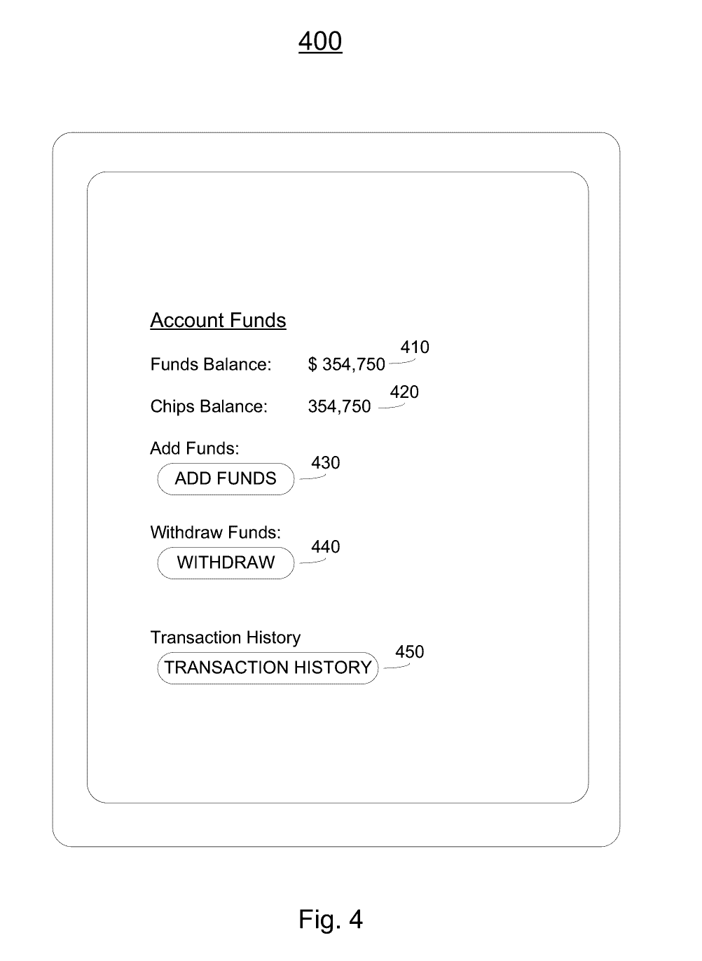

In accordance with embodiments of the present invention, a user maintains a single account with a game provider. This single account manages both real currency and virtual currency, e.g., “social chipschips.” FIG. 4 illustrates an exemplary graphical user interface (GUI) 400 for managing a player's account, in accordance with embodiments of the present invention. Graphical user interface 400 comprises an indication of a user's real currency balance 410. Such a real currency balance is available for playing real money games within jurisdictions that allow real money gaming.

Graphical user interface 400 also comprises an indication of a user's virtual currency balance 420. Virtual currency is available for wagering in jurisdictions that do not allow real money gaming. Touching, or otherwise indicating “add funds” button 430 allows a user to add funds to an account. Funds may be sourced from any suitable electronic funds source, for example, a credit card, a wireless carrier, a bank account, an online payment provider, and the like. Graphical user interface 400 further comprises a “withdraw funds” button 440. As the label implies, this button allows a user to withdraw funds from an account. This button may also allow a user to redeem social chipschips for virtual items within the gaming application, e.g., banners, tokens and the like.

Also included in graphical user interface 400 is a “transaction history” button 450. Touching, or otherwise indicating “transaction history” button 450 allows a user to view a history of transactions, e.g., deposits, withdrawals, redemptions, etc., within the user's account.

It is appreciated that a single account, as displayed in graphical user interface 400, encompasses both real and virtual money accounting. In accordance with embodiments of the present invention, there is no difference in management of the single account from a user perspective.

In accordance with embodiments of the present invention, real money balances and social chipschips balances may be kept separately. For example, a user is unable to withdraw the social chips. However, a user can withdraw real money. The real money and social chips are not interchangeable. Both the account balances are different and the account balances may be updated independently.

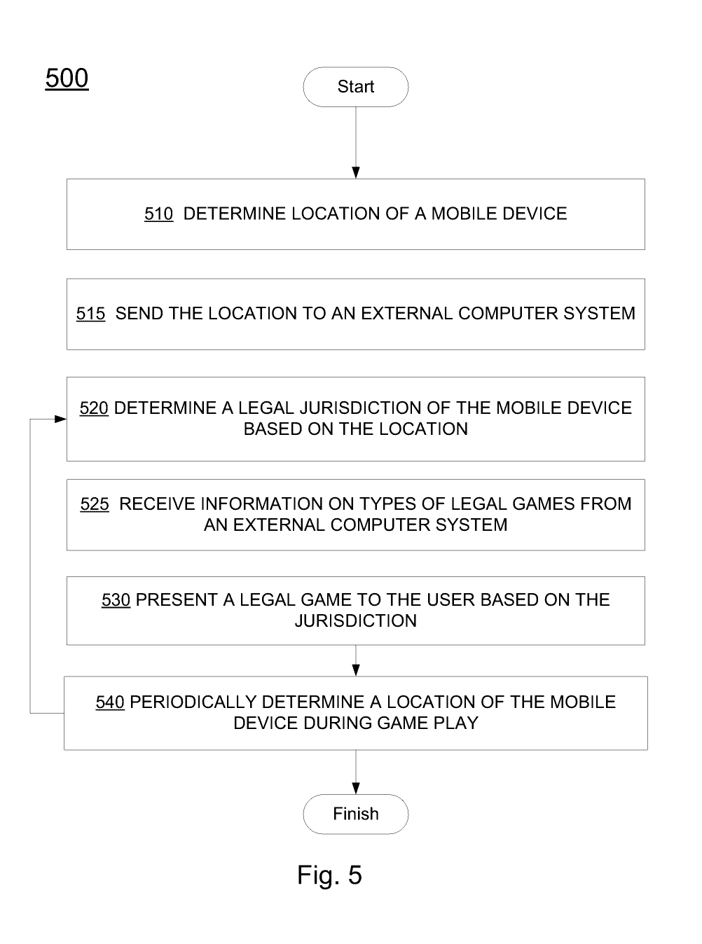

FIG. 5 illustrates an exemplary method 500 for seamless transitions between game types, in accordance with embodiments of the present invention. In 510, a mobile device determines its location. In optional 525, the location is send to an external computer system, e.g., a server computer system. In 520, based on the location, a legal jurisdiction is determined. The granularity of the jurisdiction is based on gambling laws. For example, gambling laws may vary by country, state or province, county, parish, city, etc. In optional 525, information on types of legal games is received at the mobile device from an external computer system. Based on the jurisdiction, in 530 a type of game is made available to a user of the mobile device. The game type corresponds to the legal limits of gambling for the jurisdiction, and may be selected from, for example, real money gaming, social chips gaming and/or fantasy gaming. The determination of jurisdiction based on location, and the types of games legally available in the jurisdiction, may be made locally by the device, or made by a remote computer in response to information of the mobile device's location and communicated back to the mobile device.

In optional 540, the mobile device periodically checks its location during game play. Responsive to such a subsequent location determination, a gaming application may “redetermine” a legal jurisdiction and make a legal type of game available to the user. In accordance with some embodiments, operations 520 and 530 may be repeated only if the device's location has changed. Accordingly, the type(s) of games available may be updated and/or changed according to a device's changing location.

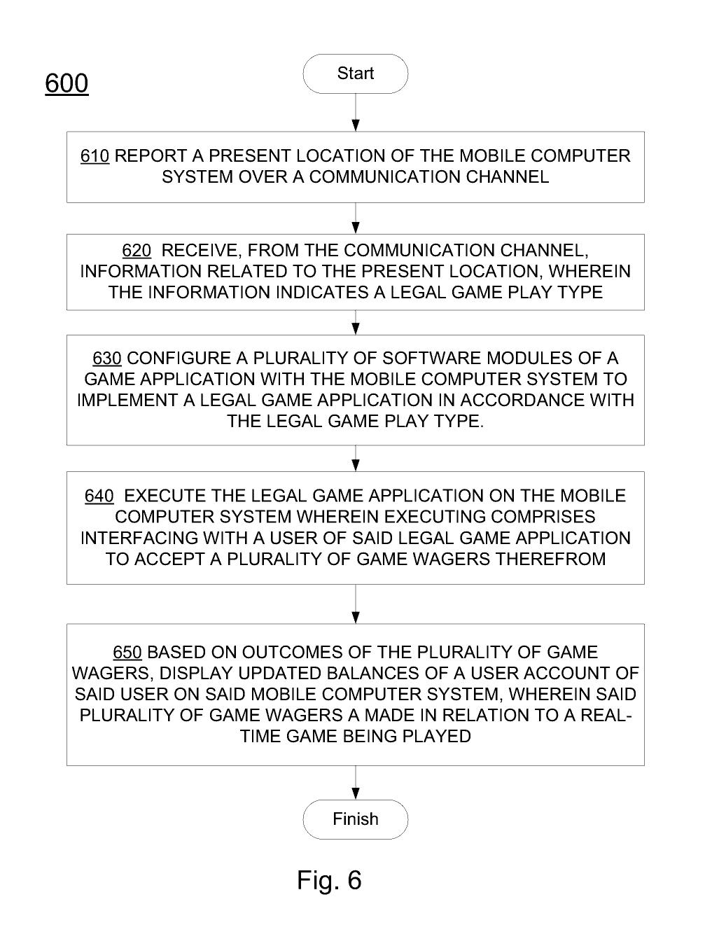

FIG. 6 illustrates an exemplary method 600 for game play, in accordance with embodiments of the present invention. In 610, a present location of a mobile computer system is reported by the mobile computer system over a communication channel. In 620, information related to the present location of the mobile computer system is received by the mobile computer system. The information indicates a legal game play type.

In 630, a plurality of software modules of a game application within the mobile computer system is configured to implement a legal game application in accordance with the legal game play type. In 640, the legal game application is executed on the mobile computer system. Executing comprises interfacing with a user of the legal game application to accept a plurality of game wagers therefrom. In 650, based on outcomes of the plurality of game wagers, updated balances of a user account of the user are displayed on the mobile computer system, wherein the plurality of game wagers are made in relation to a real-time game being played.

Embodiments in accordance with the present invention provide systems and methods for seamless transitions between game types for portable computer systems. In addition, embodiments in accordance with the present invention provide systems and methods for seamless transitions between game types for portable computer systems based on geolocation of a mobile device. Also, embodiments in accordance with the present invention provide systems and methods for seamless transitions between game types for portable computer systems without user intervention. Further, embodiments in accordance with the present invention provide systems and methods for seamless transitions between game types for portable computer systems that present a unified account structure to a user. Still further, embodiments in accordance with the present invention provide systems and methods for seamless transitions between game types for portable computer systems that are compatible and complementary with existing systems and methods of on-line and/or mobile gaming.

Various embodiments of the invention are thus described. While the present invention has been described in particular embodiments, it should be appreciated that the invention should not be construed as limited by such embodiments, but rather construed according to the below claims.

What is claimed is:

1. A computer implemented method comprising:
determining a location of a mobile device;
determining a legal jurisdiction of the mobile device based on said location; and
automatically presenting a legal type of game to a user of said mobile device based on said legal jurisdiction.

2. The computer implemented method of claim 1 further comprising:
sending said location of the mobile device to an external computer system.

3. The computer implemented method of claim 2 wherein said determining a legal jurisdiction of the mobile device is performed external to said mobile device.

4. The computer implemented method of claim 3 further comprising:
receiving, from an external computer system, information of one or more legal game types corresponding to said legal jurisdiction.

5. The computer implemented method of claim 1 further comprising:
determining an updated location of said mobile device periodically during game play; and
updating said legal type of game based on said updated location.

6. The computer implemented method of claim 5 wherein said updating said legal type of game comprises:
repeating said determining an updated legal jurisdiction of the mobile device based on said updated location and presenting a legal game to the user based on said updated legal jurisdiction responsive to a change in the location of the mobile device.

7. The computer implemented method of claim 1 wherein said legal type of game is selected from real money games and virtual currency games.

8. The computer implemented method of claim 1 wherein said legal type of game is selected from real money games, virtual currency games and fantasy games.

9. The computer implemented method of claim 1 further comprising:
automatically updating a unified user account based on game play of said legal type of game, wherein said unified user account comprises both a social chips balance and a real-money balance.

10. A method of game play, said method comprising:
in a mobile computer system, reporting a present location of said mobile computer system over a communication channel;
said mobile computer system receiving, from said communication channel, information related to said present location wherein said information indicates a legal game play type;
configuring one or more software modules of a game application within said mobile computer system to implement a legal game application in accordance with said legal game play type;
executing said legal game application on said mobile computer system wherein said executing comprises: interfacing with a user of said legal game application to accept a plurality of game wagers therefrom; and
based on outcomes of said plurality of game wagers, displaying updated balances of a user account of said user on said mobile computer system, wherein said plurality of game wagers are made in relation to a real-time game being played.

11. The method as described in claim 10 wherein said one or more software modules comprise: a real money wager game play module; a fantasy wager game play module; and a social chips game play module.

12. The method as described in claim 10 further comprising repeating said configuring based on an updated present location of said mobile computer system.

13. The method as described in claim 12 wherein said present location and said updated present location are both based on a Global Positioning System (GPS) device of said mobile computer system.

14. The method as described in claim 10 further comprising:
automatically determining said outcomes of said game wagers based on real-time events of said real-time game; and
automatically updating said balances of said user account based on said outcomes.

15. The method as described in claim 10 wherein said configuring is performed transparently to said user.

16. The method as described in claim 10 wherein said user account comprises:
a balance of real money; and
a balance of social chips.

17. The method as described in claim 10 wherein said legal game type is defined based on laws pertinent to a jurisdiction and wherein said present location is determined to be within said jurisdiction.

18. The method as described in claim 10 wherein said mobile computer system is a smart phone.

19. A mobile electronic system comprising:
one or more processors coupled to a bus;
a memory coupled to said one or more processors, wherein said memory comprises a gaming application;
a position determining system coupled to said bus operable to determine a geolocation of said electronic system;
a graphical user interface coupled to said bus;
wherein said mobile electronic system is configured to:
report a present location of said mobile electronic system over a communication channel;
receive, from said communication channel, information related to said present location wherein said information indicates a legal game play type;
automatically configure one or more software modules of said gaming application within said mobile electronic system to implement a legal game application in accordance with said legal game play type;
execute said legal game application, wherein said executing comprises: interfacing with a user of said legal game application to accept a plurality of game wagers therefrom; and
based on outcomes of said plurality of game wagers, display updated balances of a user account of said user on said display, wherein said plurality of game wagers are made in relation to a real-time game being played.

20. The mobile computer system as described in claim 18 wherein said one or more software modules comprise: a real money wager game play module; a fantasy wager game play module; and a social chips game play module.

21. The mobile computer system as described in claim 18 wherein said mobile electronic system is further configured to automatically configure said one or more software modules of said gaming application based on an updated present location of said mobile computer system.

22. The mobile computer system as described in claim 18 wherein said automatic configuration is performed transparently to said user.

23. The mobile computer system as described in claim 18 wherein said user account comprises:
a balance of real money; and
a balance of social chips.

24. The mobile computer system as described in claim 10 wherein said legal game type is defined based on laws pertinent to a jurisdiction and wherein said present location is determined to be within said jurisdiction.

25. An article of manufacture including a computer readable medium having instructions stored thereon that, responsive to execution by an electronic system, cause said electronic system to perform operations comprising:
determining a location of a mobile device;
determining a legal jurisdiction of the mobile device based on said location; and
automatically presenting a legal type of game to a user of said mobile device based on said legal jurisdiction.
